(19) United States
(12) Patent Application Publication
(10) Pub. No.: US 2012/0201326 A1
(43) Pub. Date: Aug. 9, 2012

(54) SIGNAL AND DEVICES FOR WIRED NETWORKS

(75) Inventors: Danny Burns, Suffolk (GB); Steve Farmer, Bedfordshire (GB)

(73) Assignee: APOLLO FIRE DETECTORS LIMITED, Hampshire (GB)

(21) Appl. No.: 13/383,896

(22) PCT Filed: Jun. 30, 2010
(86) PCT No.: PCT/GB10/01270

§ 371 Date: Apr. 27, 2012

(30) Foreign Application Priority Data
Jul. 14, 2009 (GB) 0912248.2

(51) Int. Cl. H04L 27/04

(52) U.S. Cl. 375/295

(57) ABSTRACT

A signal for use on a wired network interconnecting electronic devices, comprising: a base voltage for conveying power to the electronic devices; a pulsed voltage signal bearing coded information for transfer between the electronic devices; and a digital signal superimposed onto selected portions of the pulsed voltage signal, wherein the digital signal comprises a carrier signal modulated by a digital encoded data signal for transfer between the electronic devices, and the digital encoded data signal represents an original digital data signal encoded in accordance with a code scheme that ensures that there is at least one transition, between high and low binary values, between every data bit of the data signal. This is used in fire alarm networks, for example, to convey multimedia or other data such as control signals, whilst maintaining compatibility with existing protocols using the pulsed voltage signal.

### CROSS REFERENCE TO RELATED APPLICATIONS

This application is a national phase application of PCT Application No. PCT/GB2010/001270, filed Jun. 30, 2010 which claims priority to United Kingdom Patent Application No. 0912248.2, filed Jul. 14, 2009, the entire contents of which are hereby incorporated by reference therein.

The invention is in signal compositions for use on wired networks and in electronic devices for use on such networks, as well as in related methods of operation. It is especially but not exclusively applicable to fire alarm systems with sounders and detectors (or combined sounder/detectors) linked by a common network cable, e.g. a fireproof cable to a control panel.

### BACKGROUND OF THE INVENTION

In known fire alarm systems, fire detectors are distributed throughout a building, the fire detectors being networked together and monitored by a central controller. Monitoring the fire detectors involves transmitting a sequence of polling signals to each detector and receiving signals indicating the status of the detector. If the presence of a fire is detected then the central controller can transmit a signal to alarm sounders located at various points around the building. Such a system is disclosed in our GB-A-2178878 which is incorporated by reference herein.

The sounders emit an audible warning such as a high pitched tone or siren, indicative of the need to evacuate the building. A more specific audible warning, such as a verbal command to evacuate the building or part of the building, can also be generated. A number of voice messages may be pre-recorded and stored in a memory of the sounder, which can be triggered by the signal from the central controller. A disadvantage is that customising the system to suit a particular environment is difficult because the voice messages are pre-programmed and can only be accessed from an interface at the sounder.

It is desirable to include a voice communication capability in a building for fire-fighters to communicate to each other or to other occupants within the building. It is known to provide public address systems in a building for such a purpose. However, existing public address and intercom systems are discrete audio products, separate from any fire alarm systems. The public address system and fire alarm system therefore require separate installation and operation.

Where fire detectors and sounders draw power from the network which is usual, power conservation is an important consideration, particularly during an alarm condition when many devices are drawing power from the network simultaneously.

A further consideration in introducing extra functionality into fire alarm systems or other installations is backwards compatibility. It is desirable to allow existing equipment, which recognises existing transmission protocols, to function without the need for replacement.

Our co-pending UK Patent Application No. 0802502.5 relates in fact to the invention of a signal for use on a wired network interconnecting electronic devices, comprising:
a base voltage for conveying power to the electronic devices;
a pulsed voltage signal bearing coded information for transfer between the electronic devices;
and a digital signal superimposed onto selected portions of the pulsed voltage signal, wherein the digital signal comprises a carrier signal modulated by a data signal for transfer between the electronic devices

There is a need for an optional modulation method for the data signal, and the present invention provides a signal for use on a wired network interconnecting electronic devices, comprising: a base voltage for conveying power to the electronic devices; a pulsed voltage signal bearing coded information for transfer between the electronic devices; and a digital signal superimposed onto selected portions of the pulsed voltage signal, wherein the digital signal comprises a carrier signal modulated by a digital encoded data signal for transfer between the electronic devices, and the digital encoded data signal represents an original digital data signal encoded in accordance with a code scheme that ensures that there is at least one transition, between high and low binary values, between every data bit of the data signal.

This invention allows for more rapid transfer of information reliably over an existing pulsed voltage signal protocol, such as in fire alarm networks. The digital signal will be at a substantially higher frequency than that of the pulsed voltage signal. In addition, as illustrated below, there may also be superimposed a current signal, causing a superimposed pulsed voltage signal, travelling in the opposite direction from the said signal in a bidirectional network.

The invention also provides a computer-readable medium storing a computer program which, when loaded in an electronic device, causes that device to generate or process a signal, in accordance with the above-defined invention, that is transmitted from or received by that device.

The invention also provides a wired network interconnecting electronic devices, wherein the electronic devices are configured to transmit and/or receive a signal according to the invention.

The invention also provides an electronic device configured for communication with other electronic devices over a network as defined above, the device comprising means for generating and/or for processing a signal as defined above, and means for drawing operating power from that signal.

Such a device may be a sounder or loudspeaker device, or an interface device e.g. a voice communications terminal such as a fire telephone, EVC outstation or call point, a detector device or a network control device.

The invention also provides a method of operating a sounder or loudspeaker device according to the invention, wherein the data signal comprises audio, comprising receiving the said signal from the network said signal comprising control data and multimedia data combined together, separating the control data from the multimedia data, storing the multimedia data in the memory, and outputting the multimedia data from the memory to a transducer.

The invention also provides a method of uploading an audio voice file from a network control device according to the invention to a plurality of networked devices each according to the invention, comprising:
inputting an audio voice file into the network control device;
   storing the audio voice file in the memory of the network control device,
   retrieving the audio file from the memory,
   combining the audio voice file with control data and encoding them using the said code scheme,
transmitting the audio voice file and control data within the said signal to at least one of the networked devices,
   receiving the audio voice file and control data at the networked device or devices and storing the audio voice file in the memory of the device or devices.

The invention also provides a method of operating a network according to the invention, including the further steps of monitoring by the plurality of detector devices at least one external condition in order to determine the presence of a fire, and generating an alarm signal at least one of the sounder or loudspeaker devices if the presence of a fire is detected.

The invention also provides a method of operating such a network, comprising receiving a voice input at the network control device to produce a voice data signal, transmitting the voice data signal within the said signal to the sounder and/or loudspeaker devices, and outputting the voice data signal to the transducers of the respective devices.

Where a network device has a voice input means, the invention also provides a method comprising inputting a voice signal into that device, transmitting the voice signal within the said signal to the detector control apparatus and outputting the voice signal at the detector control apparatus.

### BRIEF DESCRIPTION OF THE DRAWINGS

Embodiments of the invention will be described with reference to the accompanying drawings, in which:

FIG. 1 is a diagram of a fire alarm system embodying the invention.

FIG. 2 is a diagram of a detector apparatus for use in the fire alarm system shown in FIG. 1.

FIG. 3 is a diagram of an audio unit of the detector apparatus shown in FIG. 2.

FIG. 4 is a diagram of a detector control apparatus for use in the fire alarm system shown in FIG. 1

FIG. 5 is a diagram of an audio unit of the detector control apparatus shown in FIG. 4.

FIG. 6 is a diagram of an alternative fire alarm system embodying the invention, having a network comprising multiple loops and a single alarm control module.

FIG. 7 is a diagram of a further alternative fire alarm system embodying the invention having a network comprising multiple loops and two alarm control modules.

FIG. 8 is a diagram showing the data structure of a polling signal for use with the fire alarm system of any of FIGS. 1 to 7.

FIG. 9 is a diagram showing a carrier signal superimposed on the polling signal shown in FIG. 8.

FIG. 10a is a diagram showing a carrier signal superimposed on the polling signal shown in FIG. 8 in accordance with a continuous burst mode.

FIG. 10b is a diagram showing a carrier signal superimposed on the polling signal shown in FIG. 8 in accordance with an initiation burst mode.

FIG. 10c is a diagram showing a carrier signal superimposed on the polling signal shown in FIG. 8 in accordance with a zero burst mode.

FIG. 11 shows the data structure of an uplink sub-frame, the uplink sub-frame being a portion of data carried by the carrier signal superimposed on the polling signals as shown in FIG. 9.

FIG. 12 shows the relationship between the uplink sub-frames, as shown in FIG. 11 and downlink sub-frames (not illustrated).

FIG. 13 represents bi-phase mark encoding of a typical bit sequence.

FIG. 14 represents modulation using the encoded signal of FIG. 13.

FIG. 15 is a flow diagram of the functions of part of a transmitter embodying the invention.

FIG. 16 is a flow diagram of the functions of part of a receiver embodying the invention.

### DESCRIPTION OF THE PREFERRED EMBODIMENTS

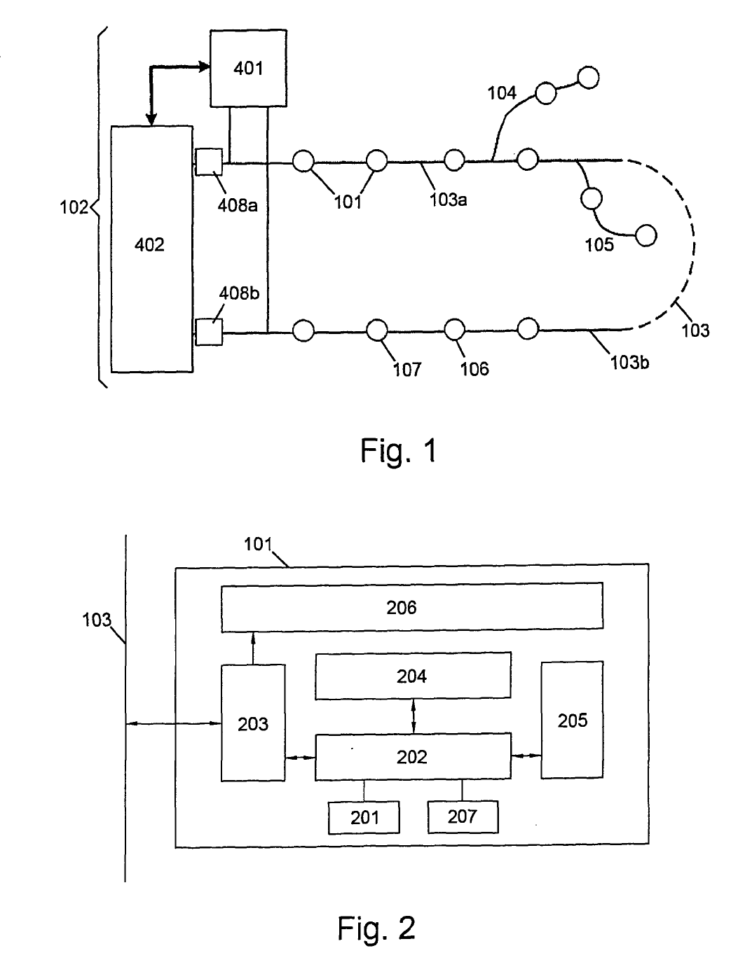

FIG. 1 shows a voice enhanced fire alarm system embodying the invention. The system comprises a detector control apparatus 102 connected to a databus network of detector apparatuses 101 linked by fire proof electric cabling. The cabling comprises a pair of wires, which allow power and information to flow in either direction. The network comprises a main loop structure 103, having two legs 103a and 103b. The network also has two spurs 104, 105. The fire alarm system of the preferred embodiment supports up to 255 detector apparatuses on a network of 2 km of cabling. The invention is not limited to this number of detector apparatuses and length. Other devices as well as detector apparatuses may be present on the network 103, such as manual call points 106 and isolators 107.

Each detector apparatus 101 is located at a different strategic point around a building and may be located on a wall or ceiling of a room or corridor.

The detector control apparatus 102 is used to monitor the detector apparatuses 101 and also to transmit voice data to the detector apparatuses 101. The voice data may be messages either for storage by each detector apparatus 101 or for live broadcast by them.

FIG. 2 is a schematic diagram showing the layout of a detector apparatus 101. The detector apparatus 101 has a detector unit 201 having a portion exposed to the environment in which the detector apparatus 101 is located. The sensor portion can measure changes in the environment, such as the increase in temperature or in carbon monoxide associated with a fire or the decrease in optical transmissivity of infrared or visible light due to the presence of smoke. In another embodiment the detector unit 201 may be capable of detecting other conditions, for example the presence of gas, radiation or intruders.

The detector unit 201 is connected to a control unit 202, which receives signals from the detector unit 201 representative of the present state of the environment in which the detector apparatus 201 is located. The control unit 202 is also connected to a line interface 203 capable of transmitting and receiving signals to and from the network 103. The line interface 203 is arranged to transmit signals received from the control unit 202 to the network 103 and to transmit signals received from the network 103 to the control unit 202. The signals handled by the line interface 203 comprise control data and multimedia combined together, the details of which will be described below. The control unit 202 is further connected to a memory 204 for storing multimedia data files and the control unit 202 is capable of reading selected multimedia data files from the memory 204 and writing data files to the memory 204. The multimedia data files represent voice messages and the memory 204 is capable of storing eight voice messages, each message having a duration of 30 seconds, entailing a storage capacity for each message of the memory of 8 Mbits.

The control unit 202 is connected to an audio unit 205, which is arranged to receive control signals and voice data signals from the control unit 202. The voice data signals may be voice messages originating from the memory 204 or they may be live-streamed from the network 103 when the system is operating in a voice communication mode. The voice communication mode includes a public address (PA) mode whereby multiple detector apparatuses in the network may receive live-streamed voice data, and an intercom mode, where a communication channel is opened between selected detector apparatuses. The control data received from the network includes prioritisation information to indicate the output priority of the voice data received. Live-streamed voice data has a higher priority than pre-stored voice messages and will override voice messages being output. Voice messages will either be blocked in favour of the live-streamed voice data or both voice messages and live-streamed voice data will be output simultaneously, with the live-streamed voice data dominating.

The voice messages are stored in the memory 204 in digital form, for instance in WAV format. The control unit 202 has a digital to analogue converter for converting digital voice messages to an analogue signal prior to transmitting the voice messages, preferably in an uncompressed format for optimal signal-to-noise performance, to the audio unit 205.

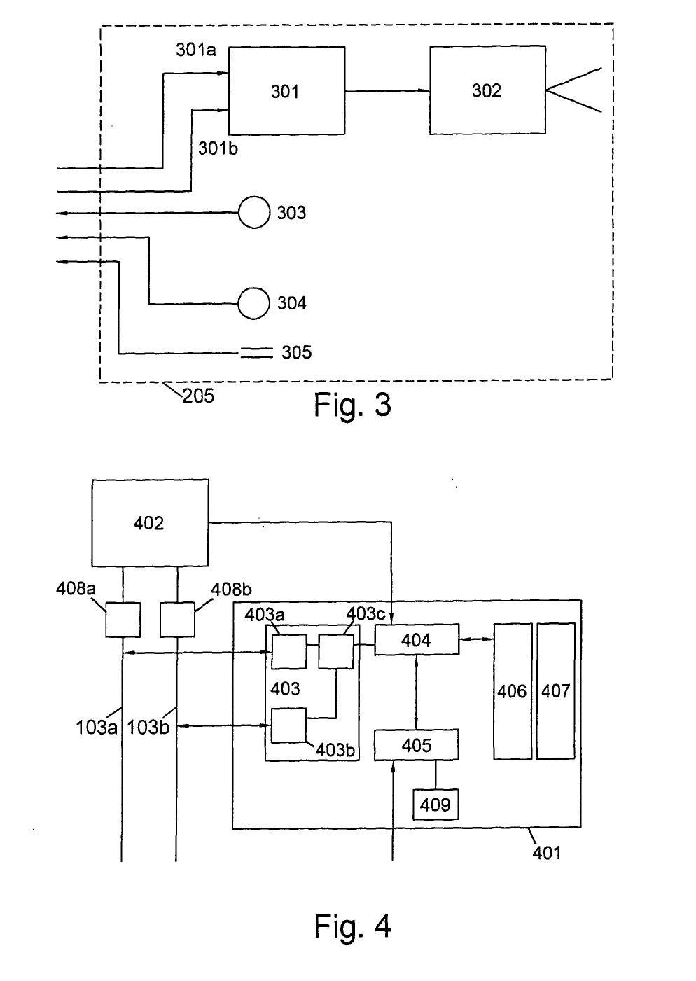

The audio unit 205 is shown in detail in FIG. 3, and comprises an amplifier 301 and a transducer 302. The amplifier 301 is preferably of a Class D type in order to maximise efficiency: the output quality of voice messages is of secondary importance to efficient power use. The amplifier is provided with a signal input 301a for receiving voice messages from the control unit 202 and a gain control input 301b for receiving gain control signals from the control unit 202. The transducer 302 is a loudspeaker of the piezo ceramic type in order to minimise power consumption. The sound pressure levels are preferably greater than 86 dBA at 1 metre. In another embodiment the transducer 302 is a screen or projector for reproducing video images, or may be a combination of screen, projector and loudspeaker.

The control unit 202 has a tone generator for generating a non-voice alarm signal, such as a siren, for output on the transducer 302.

The audio unit 205 includes a dynamic level control facility, whereby a microphone 303 is arranged to measure ambient sound levels between outputting voice messages. The measured sound levels are used by the control unit 202 to set a threshold value and to adjust the gain of the amplifier 301 to ensure that the audio output level is always a predetermined level, e.g. 20 to 50 dB above ambient threshold level, which is a requirement of BS5839-8:1998. In the fire alarm system power management on the network is important, especially during an alarm condition when most detector apparatuses will be drawing power. The technique of dynamic level control reduces the power consumed by detector apparatuses in locations where ambient noise levels are low, for instance in areas where evacuation is complete.

The control unit 202 is programmed to be operable in a test mode for use when the system is being tested, e.g. after installation. It generates appropriate fault messages, e.g. if the sounder output level cannot be cannot be made high enough, for local display and/or transmission to the detector control apparatus 102.

The audio unit 205 has a switch 304 operable by a user to indicate that the detector apparatus should operate in a voice communications mode. When in voice communications mode the audio unit 205 is arranged to receive the output signals from the microphone 303 and transmit the signals to the control unit 202. The control unit has an analogue to digital converter for digitising analogue voice signals. A socket 305 is provided for receiving voice signals from an external microphone or data storage device, by which voice signals can be input into the detector apparatus 101 as an alternative to the microphone 303.

The detector apparatus 101 has a power supply unit 206 for providing power to the components of the detector apparatus 101. Power is supplied to the detector apparatus 101 from the network. The detector apparatus 101 operates at nominally 24V volts.

The detector apparatus 101 has an address module 207 where a unique address of the detector apparatus 101 is stored. The address module 207 comprises electro-mechanical means such as an address card of the type disclosed in European Patent number EP0362985. The address module 207 is arranged such that the control unit 202 is capable of recognising data signals received from the network 103 bearing the same address as that present in the address module 207. The address module 207 is further arranged such that the control unit 202 is capable of transmitting data signals conditioned to include the address in the address module 207. The structure of the data signals will be described in more detail below.

The detector apparatus 101 comprises two sections that may be separated. The first section is a base unit, which may be fixed to a surface such as a wall or ceiling in a building. The control means 202, the line interface 203, the memory 204, the audio unit 205 and the power supply unit 206 are provided in the base unit. The second section includes the detector unit 201 and is removably attached to the base unit by means such as a bayonet fitting. The detector unit 201 may be removed for replacement or for fitting an alternative type of detector unit 201.

Detector control apparatus 102 is split into a voice control module 401 and an alarm control module 402, as shown in FIG. 4. The voice control module 401 monitors the voice network and controls the voice messages that are output by the detector apparatus 101. The alarm control module 402 monitors the network of detector apparatuses in order to determine the presence of an alarm condition, and determines the response of the voice control module 401 to such an event.

The voice control module 401 has a line interface 403 for transmitting data signals to the network 103, and receiving data signals from the network 103. The line interface is subdivided into a master interface 403a for transmitting and receiving data signals to and from a first leg of the loop 103a and a slave interface 403b for transmitting and receiving data signals to and from a second leg of the loop 103b. Under normal operating conditions, data signals are transmitted and received via the master interface 403a. The data signals received at the slave interface 403b are monitored by a redundancy detector 403c. In the event that data signals are no longer received from the master interface 403a at the slave interface 403b, the redundancy detector 403c is capable of switching the slave interface 403b to become a second master interface, and both transmit and receive data signals.

The line interface 403 is connected to a control unit 404 capable of transmitting data signals to the line interface 403 and receiving data signals from the line interface 403. The control unit 404 has a data link to the alarm control module 402. The control unit 404 is provided with standard protocol interfaces such as RS232, RS422/485, GPIO, USB and Ethernet.

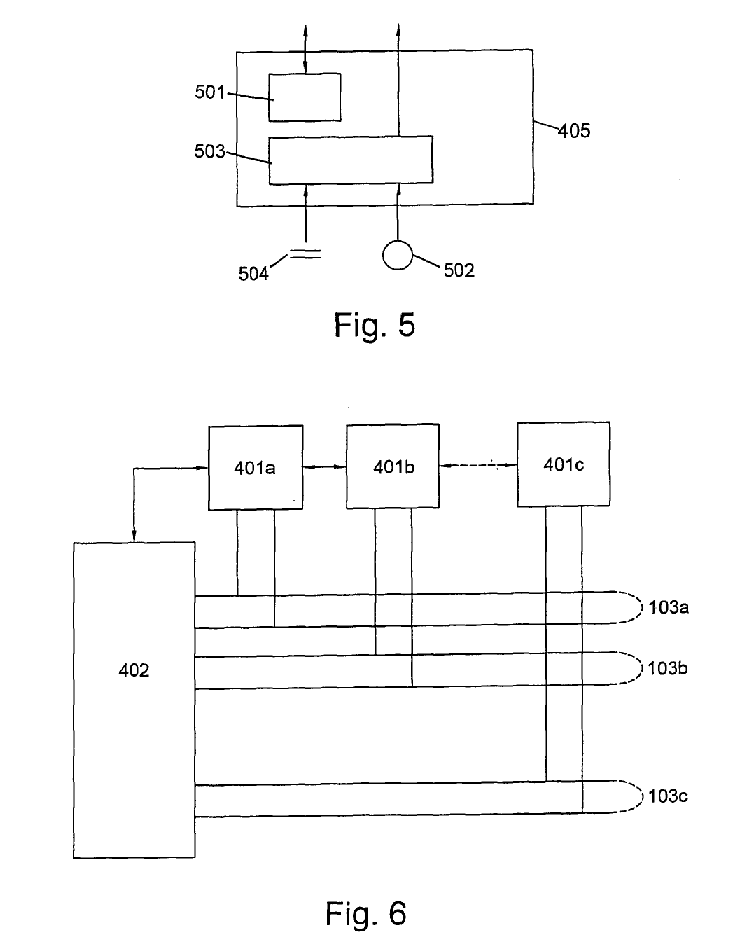

The control unit 404 is connected to an audio unit 405. The audio unit 405 has a microphone input 502 to enable the system to be used in voice communications mode. The audio unit 405 has a memory 501 as shown in FIG. 5. The memory 501 holds at least 32 concatenated voice messages of 16 bit resolution, sampled at 16 kHz, each of 30 seconds' duration. The minimum storage capacity for the memory 501 is therefore of the order of 32 Mbytes (8 Mbits per message). The control unit 404 is capable of reading voice messages from the memory 501 and transmitting voice message data and control data to the line interface 403. A microphone 502 and analogue to digital converter 503 are provided for direct voice input to the control unit 404 for use of the system in a voice communications mode. Alternatively, voice messages may be recorded and stored in the memory 501 for retrieval by the control unit 404 at a later time. A socket 504 is provided for the connection of an external microphone for direct voice input.

The control unit 404 has a further interface such as a USB port for loading pre-recorded voice messages into the memory 501.

The control unit 404 is connected to a user interface 406 comprising an LCD screen and user buttons. The user interface 406 may be used for selecting messages from the memory 501 for transmission to the network 103. A power supply unit 407 is also provided for providing power to the components of the voice control module 401.

The alarm control module 402 is of known structure, which will not be described in detail herein. The alarm control module is arranged to transmit polling signals to each of the detector apparatuses on the network. The structure of the polling signals will be described below. The alarm control module 402 is arranged to receive signals from all of the detector apparatuses on the network in order to ascertain the status of the detector apparatuses. If an alarm condition is detected the alarm control module 402 is arranged to communicate with the voice control module 401. The alarm control module 402 is isolated from the network 103 by low pass LC filters 408a and 408b, for reasons given below.

A single alarm control module 402 may be provided with a number of loops 103a, 103b, 103c, as shown in FIG. 6. In this instance a voice control module 401a, 401b, 401c is provided for the control of voice messaging on each loop 103a, 103b, 103c.

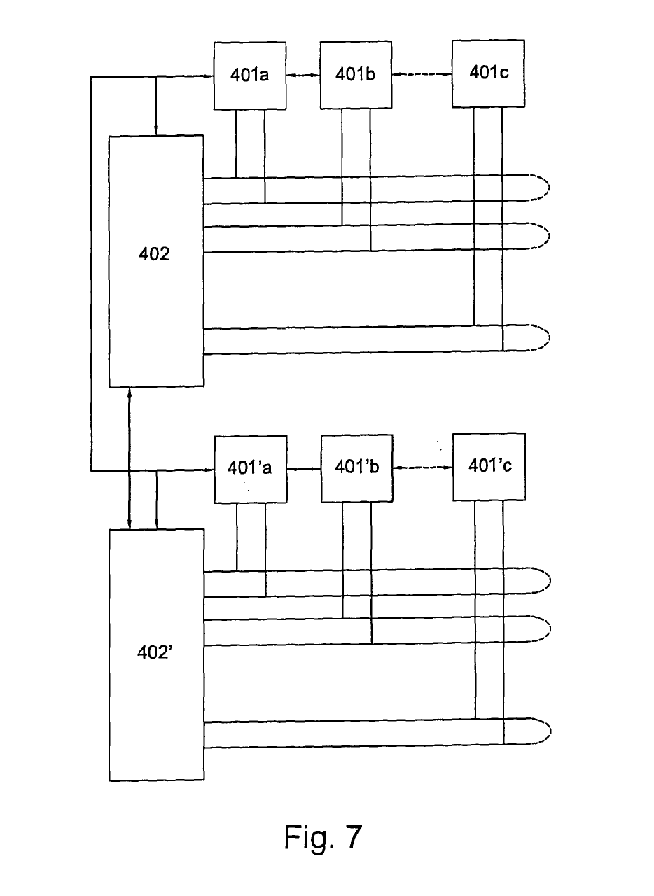

FIG. 7 shows a further enhancement of the system where multiple alarm control modules 402, 402′ are provided.

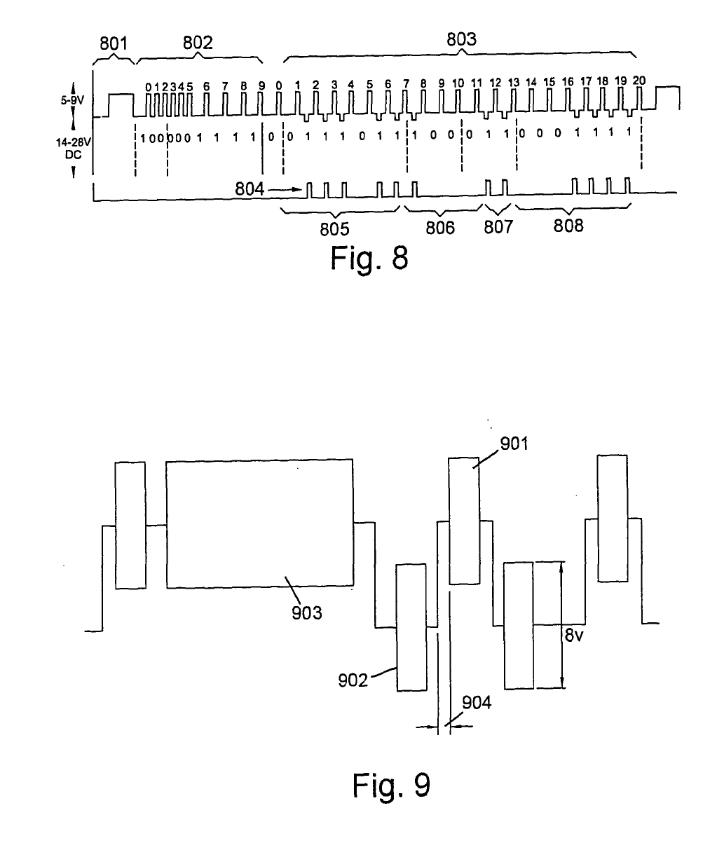

FIG. 8 illustrates the data structure for the polling signals transmitted by the alarm control module 402. The polling signals are consistent with the XP95 (registered trade mark) protocol, which is the digital open protocol of Apollo Fire Detectors Ltd. The alarm control module 402 provides a base voltage level of 14-28 volts to the line 103a, 103b, from which the detector apparatuses draw power. This base voltage varies within any installation depending upon the distance along the cable from the power source and other factors such as local cable quality and terminal connections. The base voltage is further modulated with an amplitude which is normally in the range of 5 to 9 volts. Polling data is sent in the form of frames of a specified duration. The first part of the frame is represented by a long duration voltage pulse 801, serving to reset the detector apparatuses. Pulse 801 is followed by a group 802 of ten bits in the form of positive going pulses whose mark-to-space ratio is varied according to the bit being transmitted. The first three bits of the ten bit group represent a command instruction, for instance to turn on an indicator in each of the detector apparatuses on the network. The next seven bits of the ten bit group represent an address of the detector apparatus to be polled. Following the ten bit sequence is a series 803 of twenty-one synchronising voltage pulses of constant mark-to-space ratio.

Upon receiving a data signal having a matching address to that encoded in the address field of the frame, a detector apparatus transmits a response consisting of twenty-one bits to the alarm control module 402, consisting of current pulses 804. The transmissions are thus bidirectional. The current pulses 804 cause corresponding voltage drops to occur, which are detected by the alarm control module 402. The twenty-one bit response from the detector apparatus is, in effect, a third transmission component of the signal on the databus, and it consists of seven bits of status information 805, where the value of the parameter measured by the detector unit 201 is reported. This is followed by command bits 806 and bits 807 indicating the type of device being polled. The seven bit address of the detector apparatus is confirmed back to the alarm control module 402 in section 808.

The pulsed voltage signal 801, 802 and 803 may be considered to be made up of positive-going rectangular pulses of varying width and separation, with a binary “1” value, the binary “0” value being the gaps between pulses. The pulse width may be in the range 100 μs to 4 ms, preferably 200 μs to 2 ms, more preferably 250 μs to 1.5 ms; the pulse gaps may be in similar ranges. In the example shown in FIG. 8, the first pulse 801 is 1.5 ms wide followed by an 800 μs gap before pulse “0” of group 802. the gaps between pulses “0” to “5” of group 802 are 200 μs. The gap between voltage pulse “1” of the series 803 and the negative-going pulse caused by the first current pulse 804 is 250 μs. The gap between pulses “4” and “5” in the series 803 is 1 ms. The gap between pulse “7” of series 803 and the next (sixth) negative-going pulse is 400 μs

It will be appreciated that the pulses will not be perfectly rectangular, and that in practice they will be arcuate over the pulse transitions, to limit the effective frequency bandwidth. The pulses are slew-limited in the preferred example, to stabilise the systems that detect them and avoid overshooting.

FIG. 9 illustrates the structure of the data transmitted by the voice control module 401. The data signals are modulated onto the polling data transmitted by the alarm control module 402, details of which will be described below. The alarm control module 402 may be affected by these high frequency signals, and therefore low pass filters 408a, 408b are used to isolate the alarm control module 402 from the carrier signals transmitted on the network 103 by the voice control module 401. The data signals from the voice control module 401 represent control data and multimedia data, and they have the same frame structure as that of the pulsed voltage signal. Multimedia data includes voice messages, live-streamed voice data or video data. The maximum peak-to-peak amplitude of the carrier signal is 8 volts. The carrier signal is transmitted on high 901 and low 902 voltage pulses of the polling signals, including the initiation pulse 903. The voice control module 401 is programmed to ensure that the carrier signal is not transmitted near the leading or trailing edges of the voltage pulses and that a clearance 904 is provided to avoid corruption of either the polling signals or the carrier signal. The carrier signal has a burst duration of 0.7 milliseconds on the long initiation pulse and a duration of 0.15 milliseconds on each bit of the frame. Thus there is an intelligently-selectable burst length for the carrier signal. In this example, the voice control module 401 detects the transitions of the voltage pulses 801-803, and it allows a long burst 903 within the first pulse 801 only if it has not detected a trailing edge of that pulse, i.e. only if it is satisfied that the pulse is a reset pulse of long duration.

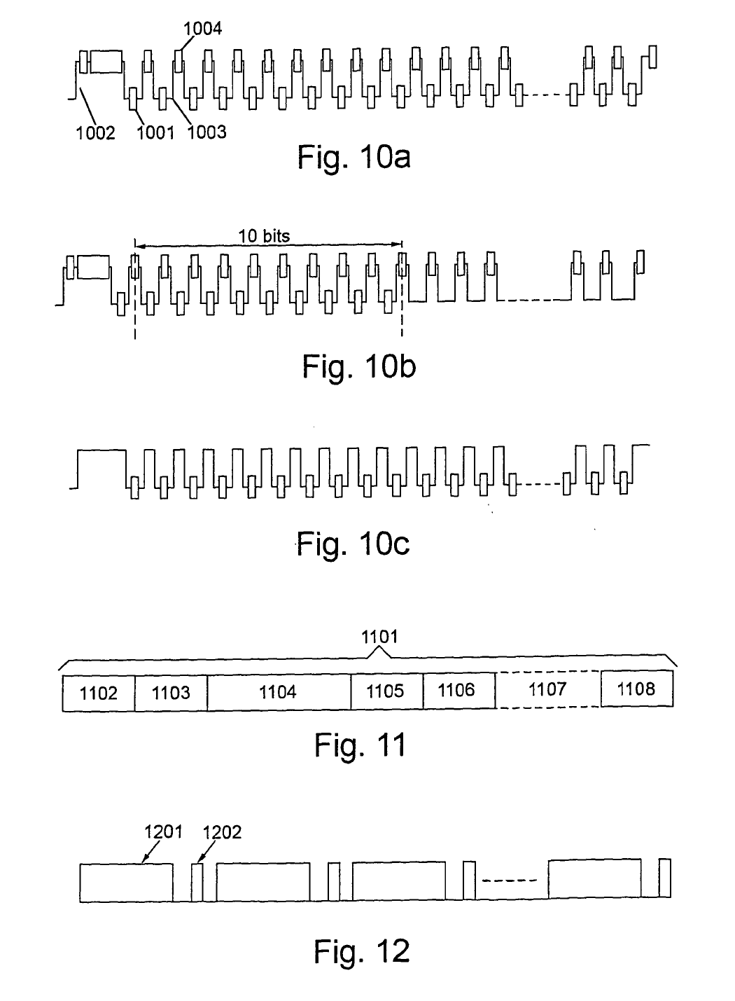

Three carrier transmission modes are possible, illustrated respectively in FIGS. 10a to 10c.

The first mode is a continuous burst mode shown in FIG. 10a, where the carrier signals 1001 are transmitted on all initiation pulses 1002, and on low 1003 and high 1004 voltage pulses. It is possible to transmit 9340 bits per frame in this mode giving a data rate of around 420 Kb/s.

In some installations there may be a risk that the carrier signal interferes with the monitoring of the current pulses 804, which are in the second part of the XP95 signal frame for example. To reduce this risk, the second mode is an initiation burst mode as shown in FIG. 10b, where carrier signals are transmitted on all initiation pulses, on high and low voltage portions of the first ten bits of the frame and on only the high voltage peaks of the synchronisation bits in the remainder of the frame. It is possible to transmit 6600 bits per frame in this mode giving a maximum data rate of around 300 Kb/s.

In the event that the peaks of voltage in the carrier signal, added to the pulsed voltage signal and the base voltage, would exceed certain thresholds in system devices such as EMC, surge protection devices, this could be avoided by using a third mode. The third mode is a zeros burst mode as shown in FIG. 10c, where carrier signals are transmitted on all low voltage pulses only. In other circumstances, a “ones” mode may be envisaged where data is transmitted on high voltage pulses only. In the zeros burst mode it is possible to transmit 4352 bits per frame giving a maximum data rate of around 200 Kb/s.

Carrier signals are transmitted from the voice control module 401. These signals are termed uplink data. Carrier signals are transmitted from a detector apparatus or other network device to the voice control module 401. These signals are termed downlink data.

The structure of uplink data transmitted by the voice control module 401 is illustrated in FIG. 11. The uplink data is packaged in an uplink sub-frame 1101. Each uplink sub-frame contains a four-bit header 1102, indicating the position of the sub-frame in a sequence. A four-bit auxiliary data field 1103 is used to indicate whether an address field is for a single detector apparatus or a group. An eight-bit address field 1104 is provided in order to indicate the destination address of the data: a zero in this field is used to indicate that the data is intended for all detector apparatuses in the network. A four-bit identifier field 1105 indicates the type of data in payload field 1107, for example voice message, live-streamed voice data or video data. A four-bit length field 1106 indicates the size of the payload field 1107. The payload field 1107 can be of any length as defined in 1106. An eight-bit error correction field is provided 1108.

The structure of the downlink sub-frame is the same as the uplink sub-frame.

The relationship between uplink sub-frames 1201 and downlink sub-frames 1202 is shown in FIG. 12. After each uplink sub-frame transmission a downlink message is transmitted in response.

### Data Encoding and Modulation

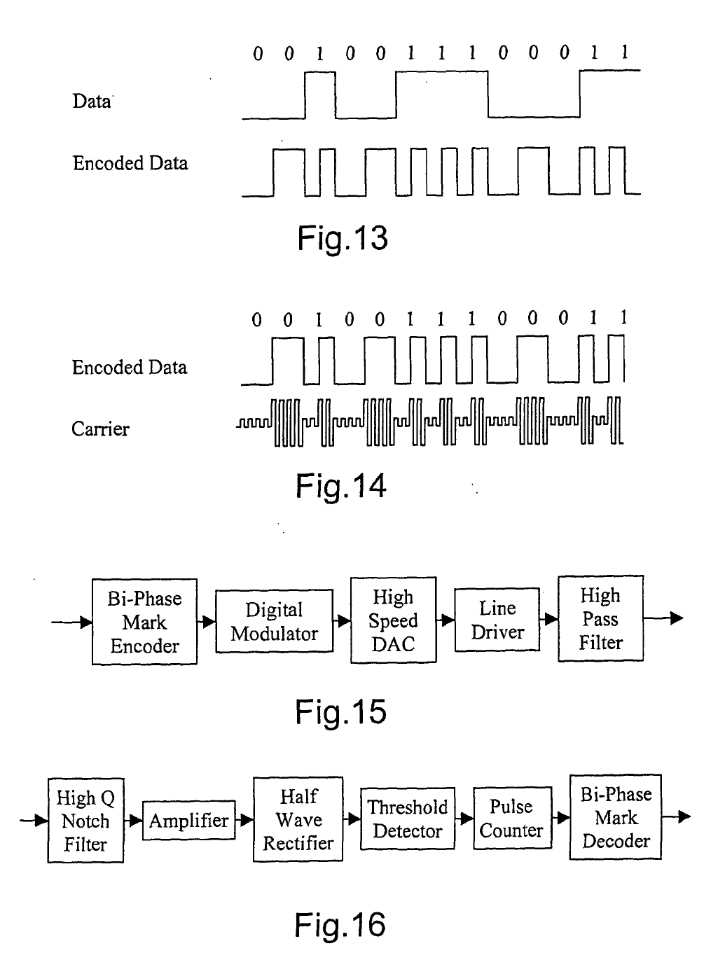

The modulation of the carrier signal with the data signal will now be described with reference to FIGS. 13 to 16 of the drawings.

As the frame length i.e. the data packet length is indeterminate, due to the need of transmission bursts to avoid the edges of the polling signal illustrated in FIG. 8, there is a risk that any long string of logic zeros or logic ones in the transmitted signal might be confused by the receiver with a gap in the transmitted frame.

Also, in order to reduce receiver threshold problems, the average DC content of the high frequency modulation should be close to zero. Otherwise, a long string of logic ones or logic zeros could cause the DC level through a series capacitor to drift up and down. A long string of the same binary value, when put through a capacitor which is DC blocking, will eventually drift to zero through the capacitor, making a sequence of logic ones appear to be a sequence of logic zeros or vice versa. This can cause incorrect bit decoding and jitter. With the encoding scheme of the present invention described below, there are many edges, so that the DC content is almost zero, allowing the data to pass cleanly through any series capacitor.

In order to reduce receiver complexity, it is considered that a signal carrier frequency is advisable, for the transmission of logic ones and logic zeros.

The transmission of high quality real time audio or video requires the receiver to be clock synchronous with the transmitter, and the provision of an encoding scheme in accordance with the invention, with at least one edge per bit, allows for clock synchronicity.

Accordingly, and in accordance with the present invention, the digital encoded data signal, which is used to modulate the carrier signal, is encoded from the original digital data signal in accordance with a code scheme that ensures that there is at least one transition, between high and low binary values, between every data bit of the data signal. Preferably, the code scheme is bi-phase mark encoding, although another possibility is the Manchester code scheme, both schemes doubling the bit rate required. 4B/5B and 8B/10B encoding schemes are also feasible, as they have plenty of transitions for clock recovery and jitter etc, but they increase the bit rate by only 25%, as 4 bits are represented by 5, or 8 by 10.

FIG. 13 illustrates a typical sequence of binary bits as numerals 0 and 1, and beneath that a voltage representing high and low bit values. Below that is the encoded version of the data signal, using bi-phase mark encoding.

This encoded scheme effectively has two bit rates i.e. two frequencies, and it is used as a mask for the carrier transmission, typically a sine wave, as shown in FIG. 14. The carrier frequency in the example of FIG. 9 is 500 kHz, but other frequencies such as 8 MHz are possible. The carrier frequency should preferably be at least four times the bit rate.

As shown in FIG. 14, a much lower amplitude carrier is transmitted during the zeros than during the ones. This ensures that the minimum amount of distortion of the carrier happens at the start of a logic one transmission. This low amplitude level will fall below the threshold detector level within the receiver, and will therefore not be decoded.

The key functions of a transmitter embodying the invention are shown in the flow diagram of FIG. 15. The transmitter may be implemented in a variety of ways, but the example shown in FIG. 15 is the preferred implementation. The original data string is encoded into a bi-phase mark string and is then converted to a carrier wave digitally into a fourteen bit representation. This is then fed into a high-speed digital-to-analog converter which produces the actual analogue carrier wave using a line driver. This analog signal is transmitted onto the line via a high pass filter by the line driver.

A receiver embodying the invention has the key functions as illustrated in FIG. 16. The bi-phase mark encoding scheme makes the receiver design quite straightforward, with its critical part being the filter. This is shown as a high Q notch filter. The filter needs to have quite a high Q and it needs to be matched as far as possible to the characteristic impedance of the cable. Once the carrier wave has passed through any required gain and filtering, the resultant signal is passed through a half wave rectifier and then a threshold detector, to produce a train of pulses. These pulses, and the spaces between them, are then decoded in a pulse counter to reproduce the original encoded data, signal, which is then in turn decoded by the bi-phase mark decoder into the original data stream. For example, if four consecutive data pulses are received, then this is interpreted as a logic zero, but if two are received, then it is interpreted as a logic one. If the gap between pulses is the equivalent of four pulses, then that equates to a logic zero, and if the gap between pulses is the equivalent of two pulses then it is ignored.

The receiver and the transmitter described above will form a component part of the electronic devices described above, that are interconnected on a wired network.

Operation of the fire alarm system will now be described. The fire alarm system is operable in a number of modes. The first mode is a steady state uploading of multimedia data to selected detector apparatuses, which is carried out while the system is actively monitoring for alarm conditions. Alternatively data upload is carried out while the system is offline. The operation of the system while the system is actively monitoring will be described below. The second mode of operation is in response to an alarm condition. The third mode of the system is as voice communications mode, which may be effected while the system is actively monitoring the status of detector apparatuses, or during an alarm condition. There are two sub-modes of voice communication: a public address (PA) mode and an intercom mode. Each mode and sub-mode will be described in turn below.

### Data Uploading Mode

During operation of the fire alarm system the alarm control module 402 constantly transmits polling signals to all of the detector apparatuses 101 on the network 103. The detector apparatuses 101 respond with the appropriate signals as described above. The detector apparatuses 101 are provided pre-loaded with voice messages for broadcast in the event of an alarm condition. However, the pre-stored voice messages may be overwritten in order to customise the system for particular applications. In order to load a particular detector apparatus with voice messages a user selects voice messages to be uploaded from the memory 501 of the voice control module 401. Alternatively, if an appropriate message is not already stored in the memory 501, new voice messages may be loaded into the memory 501, either directly by the use of microphone 502 or indirectly by loading pre-stored messages from an external memory device such as a flash memory.

When the messages have been selected, the control unit 404 of the voice control module 401 reads the voice data from the memory 505 and transmits the data to the network 103 via the line interface 403. The voice message data is transmitted in the payload sections 1107 of a series of uplink sub-frames 1101, along with control data, including a destination address of the recipient detector apparatus 1104 and control data relating to how the detector apparatus should handle the payload 1105. In this data uploading mode the control data is an instruction to load the voice data to a memory 204 of the detector apparatus. Further control data transmitted with the voice message data provides voice message identifier, so that the voice message can be retrieved from the memory 204 of the detector apparatus 101 by transmitting the voice message identifier alone to the detector apparatus 101. Yet further data transmitted with the voice message provides a voice message priority level.

Each detector apparatus 101 in the network will receive the voice message data. Each detector apparatus 101 will only process the data if the address in the address module 207 of the detector matches that in the address field of the uplink sub-frame. Each detector apparatus 101 will process the data if the address in the uplink sub-frame is a zero, indicating a message is intended for all detector apparatuses 101 in the network 103.

Upon receipt of an uplink sub-frame control unit 202 of the detector apparatus extracts the payload and writes the voice message to the memory 204, with a corresponding voice message identifier and a priority level. The detector apparatus 101 may transmit a downlink sub-frame to the voice control module 401 in order to confirm that the voice message has been successfully stored to memory 204.

### Alarm Condition

When a detector unit 201 in a detector apparatus 101 detects an alarm condition, e.g. smoke or fire, an alarm signal is transmitted by the detector apparatus 101 to the alarm control module 402. This signal need not be delayed until the detector unit 201 is polled. An alarm signal may also be raised from a manual call point 106 in the network. The alarm control module 402 will identify the location of the originating alarm signal in the network and establish a suitable response to raise the alarm around the network. The alarm control module 402 transmits instructions to the voice control module 401 indicating the messages(s) to be played and the detector apparatuses 101 to activated. The voice control module 401 then transmits an alarm control signal to the detector apparatuses 101. The alarm control signal contains a voice message identifier in order to identify a message in the memory 204 of the detector apparatus 101 to be output to the transducer 302. Alternatively the alarm control signal indicates that a tone should be generated by the tone generator.

### Voice Communications

The fire alarm system is capable of broadcasting voice data from the voice control module 401 to all detector apparatuses or other devices in the network, and from a single detector apparatus 101 or other device to all other network devices. This is termed a public address (PA) mode. The fire alarm system is also capable of transmitting and receiving voice signals between an individual detector apparatus 101 or a separate intercom device or call point, and either the voice control module 401, another individual detector apparatus 101, or another intercom device or call point. This is termed an intercom mode. Both of these sub-modes of the voice communications mode are described below.

### Public Address Mode—Voice Control Module to Networked Devices

The microphone 502 provided at the voice control module 401 is used to input voice data. This data is digitised 503 and prepared by the control unit 404 for transmission on the network 103. The voice data itself is transmitted as a payload in a series of uplink sub-frames, which also contain control data identifying a group of detector apparatuses or all of the detector apparatuses or other devices with sound transmission functionality on the network. Each recipient device identifies from the control data that the payload is live-streamed voice data and transmits it directly to the audio unit 205 to be output on the transducer 302. A priority level of 1 is included in the control data indicating that the incoming voice data should be output in preference to any recorded messages that are currently being output by the transducer 302.

### Public Address Mode—Networked Device to Networked Device

Microphone 303 on the networked device such as the detector apparatus 101 is used to input voice signals. The voice communications switch 304 on the detector apparatus 101 is activated to indicate to the control unit 202 of the detector apparatus 101 that the microphone is to be used for voice input. Voice signals are received by the audio unit 205 and transmitted to the control unit 202 and prepared for transmission to the network 103. The voice signals are packaged into the payload sections of a series of downlink sub-frames along with control data. The downlink sub-frames are transmitted to the network and received by the voice control module 401, and forwarded to recipient detector apparatuses. Each recipient detector apparatus identifies from the control data that the payload is live-streamed voice data and transmits it directly to the audio unit 205 to be output on the transducer 302. A priority level of 1 is included in the control data indicating that the incoming voice data should be output in preference to any recorded messages that are currently being output by the transducer 302.

The fire alarm system may be used in PA mode during an alarm condition to broadcast evacuation warnings, for instance. It may also be used during non-alarm conditions to broadcast general announcements or music.

### Intercom Mode

An intercom voice communication function may be required by firefighters and/or in disabled people's refuge areas in buildings.

The user interface 406 of the voice control module 401 is used to select a recipient detector apparatus 101. The microphone 502 provided at the voice control module 401 is used to input voice data. This data is digitised and prepared by the control unit 404 for transmission on the network 103. The voice data itself is transmitted as payload in a series of uplink sub-frames, which also contain control data identifying the recipient detector apparatus. The recipient detector apparatus 101 identifies from the control data that the payload is live-streamed voice data and transmits it directly to the audio unit 205 to be output on the transducer 302. Further control data indicates to the control unit 202 of the recipient detector apparatus that an intercom mode is selected. The control unit monitors the output of the detector apparatus microphone 303 for voice signals and transmits voice signals to the voice control module 401. A transducer 409 is provided at the voice control module for outputting voice signals received from the detector apparatus 101. In this way a two-way communication channel between the voice control module 401 and a detector apparatus 101 is provided. Alternatively a two-way communication channel between two detector apparatuses may be provided, whereby a detector apparatus 101 initiates communication between itself and another detector apparatus.

The detector apparatus microphone 303 may be bypassed, whereby socket 305 may be used by a fire-fighter to connect a personal communications device such as a headset, including a microphone and headphones, e.g. by a plug and socket. Alternatively, the interface for the fire-fighter could be a separate intercom call point, which may have a microphone or only an electronic terminal for a plug or socket.

The provision of a high-speed digital data carrier to the fire alarm system allows the integration of a number of features into the system. Use of control data integrated with multimedia data allows a flexible approach to functionality. Data signals may be directed to any location around the network to elicit a variety of responses. For instance, individual detector apparatuses or groups of detector apparatuses can receive instructions to output different messages to other individual detector apparatuses or groups of detector apparatuses. This is useful when an “evacuate” message is required in one area of a building, while a “standby to evacuate” message is required in another area of a building, while a fire-fighter's PA is required in still another area of the building.

The voice control module 401 is retro-fitted to fire alarm systems such as those complying with the Apollo XP95 protocol having an existing alarm control module 402 for polling and controlling detector apparatuses. Modified base units are fitted in order to take advantage of the high speed data carrier system. Existing detector units are fitted to the modified base units.

Alternatively an entire system including an alarm control panel is installed at the same time. The voice control module and the alarm control module may be integrated in the same housing.

It will be appreciated that any type of multimedia data may be stored in the voice control module memory 501 or the detector apparatus memory 204, including data representing video images. It will also be appreciated that any size memory may be utilised in order to store the multimedia data.

In the embodiment described above, the network signal has a power component, from its base voltage, in addition to the information-conveying components, and the detector apparatuses draw power from the network 103. Alternatively a separate local supply is also provided, in which instance the detector apparatus 101 is preferably arranged to operate at 24 volts.

The detector apparatus 101 can also act as a signal repeater in the network, in order to boost data signals. In this way the network may be expanded indefinitely, provided a local power supply is used for the detector apparatuses.

The address module 207 of the detector apparatus 101 may be an electronic identification means stored in a memory of the detector apparatus 101.

Voice control module voice input socket 504 and detector apparatus voice input socket 305 may be used by fire-fighters as inputs for their own voice signal generating equipment.

The network may be in the form of a line terminating at a single interface at the alarm control module 402, with detector apparatuses connected in series along the line.

As an alternative to one or more of the detector apparatuses as described above, sounder units may be provided for operation in the fire alarm system, including all of the voice communications functionality of the detector apparatuses described above, but without a detecting means. Other apparatuses may be provided for connection to the network, which transmit and receive data using a carrier superimposed upon a polling signal, such as sounder units and detector units without a voice communication function.

The carrier signal has a frequency of approximately 8 MHz in the embodiments described above. However, the carrier frequency is not limited to this value, and may be any frequency in the range 1 MHz to 16 MHz.

The rate of data transfer may vary within the range 1 to 100,000 bits per frame, or 100 to 1000 Kb/s, but may also fall outside of these ranges.

In some embodiments, two or several different carriers may be transmitted simultaneously in the same signal, to increase data capacity.

Further, the XP95 protocol described in the preferred embodiment with reference to FIG. 8 is not essential, and the invention could be applied to many alternative protocols, digital and analog. The pulsed voltage signal could represent analog data by varying pulse height or pulse width or both in accordance with earlier, non-digital protocols used in fire detection systems for example. The invention could be applied to the well-known RS232 standard for series communications; RS232 uses fixed width cells and involves a binary-coded digital signal.

The higher frequency modulation of the pulsed voltage signal could be used to convey any type of information, and it is not limited to multimedia content or commands for controlling and addressing electronic devices. It could convey any data such as are typically sent over computer or telephone networks.

The voice control module 401 could have a self-learning program, which detects the structure of each frame of the pulsed voltage signal and thus the protocol in use on the network. It could then learn that protocol and adapt the carrier signal timing accordingly.

The functions of the detectors 101 described above need not all be provided in every detector or in any detector. The detector may not have the sounder or loudspeaker functions nor the ability to store multimedia files. Instead, the network may have separate loudspeaker devices, which are uniquely addressable and which have the multimedia functions described, e.g. for selecting voice messages and transducing them to sound emitted from a loudspeaker. There may also be sounder devices which emit alarm sounds or other tones but not speech, and which are also uniquely addressable. The detectors 101 need not have intercom functionality such as a microphone, as this could be provided in a separate intercom device or a call point on the network.

In the application of the invention to intruder alarm or CCTV monitoring systems, the multimedia signal component and multimedia files would comprise video, and the system could include video display devices for video content.

What is claimed is:

1-70. (canceled)

71. A signal for use on a wired network interconnecting electronic devices, comprising:
a base voltage for conveying power to the electronic devices;
a pulsed voltage signal bearing coded information for transfer between the electronic devices;
and a digital signal superimposed onto selected portions of the pulsed voltage signal, wherein the digital signal comprises a carrier signal modulated by a digital encoded data signal for transfer between the electronic devices, and the digital encoded data signal represents an original digital data signal encoded in accordance with a code scheme that ensures that there is at least one transition, between high and low binary values, between every data bit of the data signal.

72. The signal according to claim 71, in which the code scheme is 4B/5B or 8B/10B encoding.

73. The signal according to claim 71, in which the code scheme is bi-phase mark encoding or the Manchester code scheme.

74. The signal according to claim 71, wherein the original digital data signal comprises multimedia content.

75. The signal according to claim 74, wherein the multimedia content comprises audio.

76. The signal according to claim 74, wherein the original digital data signal comprises an address of one of the electronic devices or of a group of the electronic devices.

77. The signal according to claim 71, wherein the coded information comprises a pulse width modulation of the pulsed voltage signal.

78. The signal according to claim 71, wherein the coded information comprises a sequence of binary digits.

79. The signal according to claim 71, wherein the coded information comprises a pulse height modulation.

80. The signal according to claim 71, wherein each pulse of the pulsed voltage signal is a slew-limited rectangular pulse.

81. The signal according to claim 71, wherein the coded information is analog data using pulse width and/or pulse height modulation.

82. The signal according to claim 71, wherein the signal is capable of transmission bidirectionally, and which further comprises a pulsed current signal bearing coded information for transfer between the electronic devices.

83. The signal according to claim 71, wherein each of the said selected portions of the pulsed voltage signal is spaced from the leading and trailing edges of each of its voltage pulses.

84. The signal according to claim 83, wherein the selected parts comprise high and low parts of the pulses of the pulsed voltage signal.

85. The signal according to claim 71, wherein the digital signal comprises a plurality of frames, each frame having a fixed number of digital bits.

86. The signal according to claim 85, wherein each frame comprises an address portion and a data portion.

87. The signal according to claim 86, wherein the address portion of the frame is superimposed on the high and low parts of the voltage pulses, and the data portion of the frame is superimposed only on the high parts of the voltage pulses.

88. The signal according to claim 71, wherein the carrier signal is modulated using a frequency modulation scheme.

89. The signal according to claim 71, wherein the carrier signal has a frequency in the range 100 kHz to 10 MHz.

90. The signal according to claim 89, wherein the carrier signal has a frequency in the range of 1 MHz to 16 MHz.

91. The signal according to claim 90, wherein the carrier signal has a frequency of approximately 8 MHz.

92. The signal according to claim 71, wherein frames of the digital signal have from 1 to 100,000 bits per frame.

93. The signal according to claim 92, wherein the frames have approximately 10,000 bits per frame.

94. The signal according to claim 71, wherein the data rate of the digital encoded data signal is in the range of 100 to 1000 Kb/s.

95. The signal according to claim 94, wherein the data rate is approximately 400 Kb/s.

96. The signal according to claim 71, wherein the pulse widths of the pulsed voltage signal are in the range of 100 μs to 4 ms.

97. The signal according to claim 96 wherein the pulse widths are in the range of 250 μs to 1 ms.

98. The signal according to claim 71, wherein the coded information in the pulsed voltage signal comprises an address of one of the electronic devices or a group of the electronic devices and data for that device or that group of devices.

99. The signal according to claim 71, wherein the electronic devices include a computer-readable medium storing a computer program which, when loaded in an electronic device, causes that device to generate or to process the signal that is transmitted from or received by that device.

100. A wired network comprising:
a plurality of interconnecting electronic devices, the electronic devices configured to transmit and/or receive a signal, the signal including:
a base voltage for conveying power to the electronic device;
a pulsed voltage signal bearing coded information for transfer between the electronic device and a second electronic device;
and a digital signal superimposed onto selected portions of the pulsed voltage signal, wherein the digital signal comprises a carrier signal modulated by a digital encoded data signal for transfer between the electronic devices, and the digital encoded data signal represents an original digital data signal encoded in accordance with a code scheme that ensures that there is at least one transition, between high and low binary values, between every data bit of the data signal.

101. The wired network according to claim 100, including a databus system in which each electronic device is uniquely addressable digitally.

102. An electronic device configured for communication with other electronic devices over a wired network, the electronic device comprising:
means for generating and/or for processing a signal; and
means for drawing operating power from that signal, the signal including:
a base voltage for conveying power to the electronic device;
a pulsed voltage signal bearing coded information for transfer between the electronic device and a second electronic device;
and a digital signal superimposed onto selected portions of the pulsed voltage signal, wherein the digital signal comprises a carrier signal modulated by a digital encoded data signal for transfer between the electronic devices, and the digital encoded data signal represents an original digital data signal encoded in accordance with a code scheme that ensures that there is at least one transition, between high and low binary values, between every data bit of the data signal.

103. The device according to claim 102, wherein the network is a fire detection network, the device being one or more of: a sounder; a loudspeaker; a fire detector; and a voice communications terminal.

104. The device according to claim 102, comprising said means for processing the signal, which processing means responds to the coded information and the data signal to act upon any control commands therein and to use any data content therein.

105. The device according to claim 104, in which the processing means is configured to respond to the coded information and/or the data signal to determine the address of the electronic device or devices for which they are intended, and to act upon them only if it determines a match with its own device address.

106. The detector device according to claim 103, comprising detector means arranged to detect a change in at least one external condition, said detector means being arranged to transmit over the wired network a signal indicative of a change in the at least one external condition.

107. The sounder or loudspeaker device according to claim 103, configured for receiving a signal, comprising a memory arranged to store the audio, and a transducer arranged to generate an audio output from the audio in the memory in response to control data received from the signal.

108. The device according to claim 107, comprising said processing means which is arranged to receive the control data of the data signal and to select a portion of the audio stored in the memory means to be output by the transducer, the selection being in accordance with the control data.

109. The device according to claim 107, arranged to receive the audio component of the digital encoded data signal and to transmit the audio to the transducer, so as to output the audio data to the transducer upon receipt of it from the signal and thereby to generate the audio output in real time.

110. The device according to claim 109, wherein the device is arranged to output audio received directly from the signal in preference to audio stored in the memory.

111. The device according to claim 107, wherein the audio data stored in the memory is divided into a plurality of data files.

112. The device according to claim 111, wherein each data file represents a discrete voice message.

113. The device according to claim 107, comprising detector means arranged to detect a change in at least one external condition, said detector means being arranged to transmit over the wired network a signal indicative of a change in the at least one external condition.

114. The device according to claim 107, comprising a digital to analog converter in which the audio is processed before being output by the transducer.

115. The voice communications terminal according to claim 103, comprising voice input means and an analog-to-digital converter arranged to digitise electronic signals from the voice input means and to transmit the digitised voice signals in the said signal as part of the said digital encoded data signal.

116. The device according to claim 102, including a network control device arranged to control a network, comprising a memory for storing a plurality of multimedia data files, wherein the network control device is arranged to retrieve multimedia data from the memory and to combine it with control data to form the said digital encoded data signal, and wherein the network control device has an interface arranged to transmit the said signal containing the digital encoded data signal on the network to the electronic devices on the network.

117. The network control device according to claim 116, wherein each multimedia data file represents a discrete voice message.

118. The network control device according to claim 116, wherein the control data and multimedia data are digital.

119. The network control device according to claim 116, wherein the multimedia data is uncompressed.

120. The network control device according to claim 116, comprising voice input means, an analog-to-digital converter arranged to convert a signal from the voice input means to a digital voice signal, and control means arranged to store the digital voice signal in the memory or transmit it over the interface to selected devices on the network.

121. The network control device according to claim 120, wherein the voice input means is a microphone or a socket to receive a microphone.

122. The network control device according to claim 116, further comprising polling means arranged to transmit and receive polling signals as part of the said signal to and from the network, wherein said received polling signals include data relating to the status of the devices in the network.

123. The network control device according to claim 122, wherein the transmitted polling signals include an address component by which the polling signals may be directed to an individual detector apparatus.

124. The network control device according to claim 116, wherein the received polling signals include information relating to the status of an originating device on the network, said received polling signals further including an address component by which the originating device may be identified.

125. The network control device according to claim 116, wherein the wired network includes a databus system, and wherein the databus has a first termination and a second termination connected respectively to the network control device at a first interface and a second interface to form a loop.

126. The wired network according to claim 125, wherein the network control device is arranged to transmit the said signals from the first interface, to monitor the said signal received at the second interface, and to transmit the said signal from the second interface if it detects that the said signal has not been received at the second interface from the first interface.

127. The wired network according to claim 126, wherein a plurality of databuses are connected to the network control device at a plurality of interfaces.

128. The wired network according to claim 125, constituting a fire alarm system.

129. A method of operating a sounder or loudspeaker device according to claim 107, comprising receiving the said signal from the network said signal comprising control data and multimedia data combined together, separating the control data from the multimedia data, storing the multimedia data in the memory, and outputting the multimedia data from the memory to a transducer.

130. The method according to claim 129, further comprising storing the multimedia data in the memory as a plurality of multimedia data files.

131. The method according to claim 129, further comprising outputting the multimedia data to the transducer upon receipt of the multimedia data from the network, and thereby outputting the multimedia content in real time.

132. The method according to claim 129, further comprising outputting the multimedia data upon its receipt from the network in preference to the multimedia data files stored in the memory.

133. A method of uploading an audio voice file from a network control device according to claim 116, to a plurality of networked devices, comprising;
inputting an audio voice file into the network control device;
storing the audio voice file in the memory of the network control device,
retrieving the audio file from the memory,
combining the audio voice file with control data and encoding them using the said code scheme,
transmitting the audio voice file and control data within the said signal to at least one of the networked devices,
receiving the audio voice file and control data at the networked device or devices and storing the audio voice file in the memory of the device or devices.

134. A method of operating a network according to claim 102, the network comprising a network control device, detector devices, and sounder or loudspeaker devices, the method comprising:
monitoring by the plurality of detector devices at least one external condition in order to determine the presence of a fire, and
generating an alarm signal at least one of the sounder or loudspeaker devices if the presence of a fire is detected.

135. The method according to claim 134, further comprising receiving at the network control device an alarm signal from at least one detector device, transmitting an alarm control signal from the network control device to the detector devices and sounder or loudspeaker devices, receiving the alarm control signal at one or more of those devices, and outputting an audio voice file from the memory of each of the receiving devices, in response to the alarm control signal, to its transducer.

136. The method according to claim 134, wherein each of the devices, or each of a group or groups of the devices, has a unique address and wherein the control data contains an address of the device or devices for which the data is intended, and wherein each of the plurality of the devices is arranged to recognise the address contained in the control data and to respond when this address corresponds to its own unique address, by outputting an audio voice file from its memory, selected from the memory in response to the alarm control signal, said audio voice file being output to its transducer.

137. A method of operating a network according to claim 125, comprising receiving a voice input at the network control device to produce a voice data signal, transmitting the voice data signal within the said signal to the sounder and/or loudspeaker devices, and outputting the voice data signal to the transducers of the respective devices.

138. The method according to claim 134, further comprising digitising the voice data signal by using an analog-to-digital converter, and transmitting the digitised data to the devices.

139. A method of operating a network according to claim 125, wherein at least one electronic device on the network has a voice input means, the method comprising inputting a voice signal into that device, transmitting the voice signal within the said signal to the detector control apparatus and outputting the voice signal at the detector control apparatus.

140. The method according to claim 139, wherein the voice input means is a microphone or a socket for receiving input from a personal audio system.
